(19) United States
(12) Patent Application Publication
(10) Pub. No.: US 2011/0255545 A1
(43) Pub. Date: Oct. 20, 2011

(54) SYSTEM FOR CONTROLLING VIRTUAL LAN THROUGH NETWORK

(75) Inventors: Jeong-Hun Shin, Daejeon (KR); Ho Young Song, Daejeon (KR); Tae Yeon Kim, Daejeon (KR); Dongguk Je, Daejeon (KR); Seung Hyun Yoon, Daejeon (KR); Nam Kyoung Um, Cheongju-si (KR)

(73) Assignee: Electronics and Telecommunications Research Institute, Daejeon (KR)

(21) Appl. No.: 12/962,680

(22) Filed: Dec. 8, 2010

(30) Foreign Application Priority Data
Apr. 20, 2010 (KR) 10-2010-0036513

(51) Int. Cl. H04L 12/28

(52) U.S. Cl. 370/395.53

(57) ABSTRACT

A virtual local area network (LAN) control system for controlling at least one virtual LAN through a network accessed by a plurality of terminals includes a terminal, a virtual LAN switch, and a virtual LAN controller. The terminal has a proper identifier address to access the network, or receives a proper identifier address through an external device connected to the virtual LAN switch. The virtual LAN switch sets and provides at least one virtual LAN through the network. When the terminal accesses the virtual LAN controller to request to change the configuration of the virtual LAN, the virtual LAN controller assigns authority to change the virtual LAN to the terminal so as to change from the virtual LAN to which the terminal belongs to another virtual LAN.

### CROSS-REFERENCE TO RELATED APPLICATION

This application claims priority to and the benefit of Korean Patent Application No. 10-2010-0036513 filed in the Korean Intellectual Property Office on Apr. 20, 2010, the entire contents of which are incorporated herein by reference.

### BACKGROUND OF THE INVENTION

(a) Field of the Invention

The present invention relates to a system for controlling a virtual local area network (LAN) through a network.

(b) Description of the Related Art

Under the conventional virtual LAN circumstance, a manager controls access of a terminal to a device or a switch by controlling configuration of a device or a switch with a virtual LAN function.

However, it is not easy to control the terminal having accessed the device with the virtual LAN function by controlling the configuration, and the access authority given to the terminal is removed.

Also, when the terminal accesses a device with the virtual LAN function to be included in a specific virtual LAN and use a communication service and is then included in another virtual LAN to use another communication network service, the configuration can only be changed with the help of the manager.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system for actively controlling a virtual local area network (LAN) by controlling a switch having a virtual LAN function through a network.

An exemplary embodiment of the present invention provides a virtual LAN control system including: a virtual LAN switch for setting and providing at least one virtual LAN through a network; a terminal having a proper identifier address for accessing the network or receiving a proper identifier address through an external device connected to the virtual LAN switch; and a virtual LAN controller for, when the terminal accesses to request to change the virtual LAN, providing authority to change virtual LANs to the terminal in order for the terminal to change a setting from the current virtual LAN to another virtual LAN.

Another embodiment of the present invention provides a system for controlling at least one virtual LAN through a network to which a plurality of terminals are accessed including: a virtual LAN switch for setting and providing the at least one virtual LAN through the network according to the access of the plurality of terminals; and a virtual LAN controller connected to the virtual LAN switch and when a first terminal of the plurality of terminals accesses to request to change a virtual LAN, providing authority to change the virtual LAN to the first terminal so as to change the first virtual LAN to which the first terminal belongs to a second virtual LAN.

Yet another embodiment of the present invention provides a system for controlling at least one virtual LAN through a network to which a plurality of terminals are accessed, including: a virtual LAN switch for setting and providing the at least one virtual LAN through the network according to the access of the plurality of terminals; and a virtual LAN controller connected to the virtual LAN switch, and when a first terminal of the plurality of terminals accesses to request to change a virtual LAN, providing authority to change the virtual LAN to the first terminal so as to change the first virtual LAN to which the first terminal belongs to a second virtual LAN.

### BRIEF DESCRIPTION OF THE DRAWINGS

FIG. 1 shows an example of a general virtual LAN circumstance.

FIG. 2 shows an example of an initial setting circumstance of a virtual LAN function providing system according to an exemplary embodiment of the present invention.

FIG. 3 shows an example of a changed virtual LAN circumstance under the initial circumstance shown in FIG. 2.

FIG. 4 shows another example of a changed virtual LAN circumstance under the initial circumstance shown in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

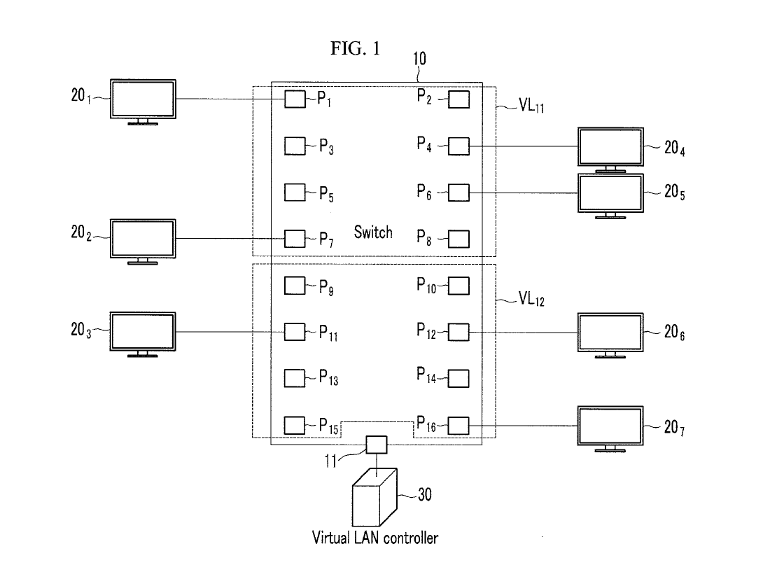

FIG. 1 shows an example of a general virtual LAN circumstance.

As shown in FIG. 1, a virtual LAN control system in the general virtual local area network (LAN) circumstance includes a switch 10 with an active virtual LAN function, terminals (20₁-20₇), and a virtual LAN controller 30.

The switch 10 includes communication ports (P₁-P₁₆) and a control end 11, and the terminals (20₁-20₇) access the switch 10 through the communication ports (P₁-P₁₆) when the virtual LAN function is activated. Here, the control end 11 can be a serial port, a telnet port and so forth. In this instance, the virtual LAN controller 30 for controlling the switch 10 accesses the switch through the communication ports (20₁-20₇) and the control end 11.

The virtual LAN VL₁₁ is set by the terminals (20₁, 20₂, 20₄, 20₅) having accessed the communication ports (P₁-P₈) of the switch 10, and the virtual LAN VL₁₂ is set by the terminals (20₃, 20₆, and 20₇) having accessed the communication ports (P₉-P₁₆).

Since the one switch 10 is operable in a like manner of a plurality of independent switches when a virtual LAN function is activated, the terminals (20₁, 20₂, 20₄, and 20₅) having accessed the virtual LAN VL₁₁ can communicate with the terminals (20₁, 20₂, 20₄, and 20₅) having accessed the virtual LAN VL₁₁, and cannot communicate with the terminals (20₃, 20₆, and 20₇) having accessed the virtual LAN VL₁₂.

When the terminal attempts to access a virtual LAN other than the currently accessed virtual LAN, the manager can change the setting of the virtual LAN of the switch 10 by controlling the virtual LAN controller 30. However, differing from the manager, the terminals (20₁-20₇) cannot directly change the virtual LAN to which they belong. Also, when the virtual LAN controller 30 has accessed the control end 11 of the switch 10, it cannot access the virtual LAN controller 30 as well as the manager.

In order for the terminal to change the setting of the virtual LAN when the virtual LAN controller 30 is connected to the communication ports (P₁-P₁₆), the following two conditions must be satisfied. First, the terminal and the virtual LAN controller 30 must be connected to the same virtual LAN, and second, the terminal must have the manager's authority.

The terminal accessed to the virtual LAN switch with the conventional virtual LAN function that is activated cannot directly change the virtual LAN to which the same terminal is accessed, and it must satisfy the limited condition in the case of changing the setting of the virtual LAN by using the virtual LAN controller 30.

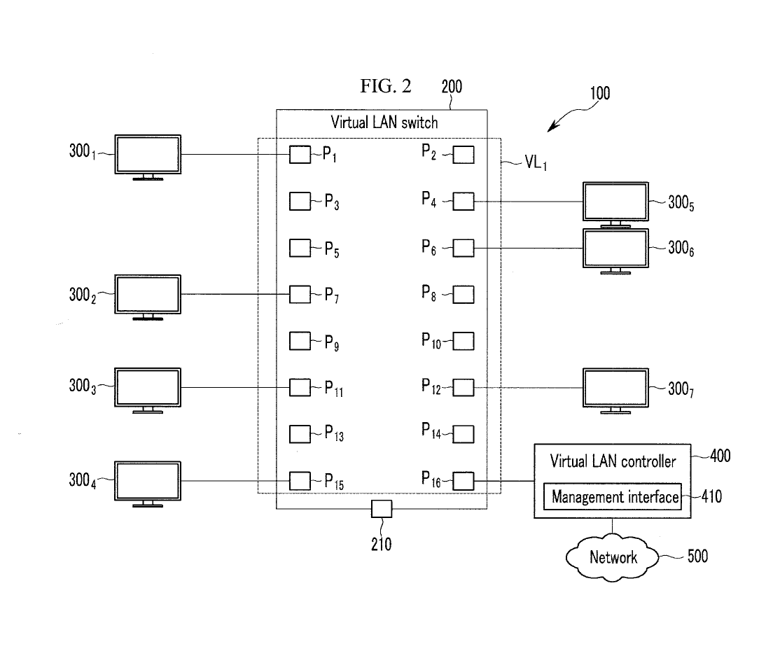

Referring to FIG. 2 to FIG. 4, a system for controlling a virtual LAN through a network according to an exemplary embodiment of the present invention will now be described.

The virtual LAN will be used not as a network that is only applicable to the L2 layer of the open systems interconnection (OSI) hierarchical structure but will be used to include any kinds of networks for logically configuring a virtual network. The virtual LAN switch includes the case of being configured with a single physical switch and the case in which at least one switch configures at least one virtual network. The virtual LAN controller can be configured as a physical device separate from the virtual LAN switch or can be included in the virtual LAN switch, and both cases provide substantially the same function and operation.

FIG. 2 shows an example of an initial setting circumstance of a virtual LAN function providing system according to an exemplary embodiment of the present invention.

As shown in FIG. 2, the virtual LAN control system 100 for controlling the virtual LAN through the network includes a virtual LAN switch 200, terminals (300₁-300₆), and a virtual LAN controller 400. In the initial circumstance of the virtual LAN control system 100, the terminals (300₁-300₆) and the virtual LAN controller 400 connected to the virtual LAN switch 200 are connected to the same virtual LAN VL₁.

The virtual LAN switch 200 is a device or a switch with the activated virtual LAN function, and includes communication ports (P₁-P₁₆) and a control end 210. The virtual LAN switch 200 sets and provides a virtual LAN VL₁ when the terminals (300₁-300₆) and the virtual LAN controller 400 access the virtual LAN switch 200 through the communication ports (P₁-P₁₆) and the control end 210 in the initial circumstance.

The terminals (300₁-300₆) access the virtual LAN controller 400 through the communication ports (P₁-P₁₆), and change the virtual LAN VL₁ when it has a proper Internet protocol (IP) address. That is, when a proper IP is assigned, the terminals (300₁-300₆) use a communication protocol such as the hypertext transfer protocol (HTTP), secure sockets layer (SSL), or teletype network (Telnet) to access the virtual LAN controller 400 directly or through a management interface 410 of the virtual LAN controller 400, and changes the virtual LAN VL₁. In addition, the terminals (300₁-300₆) can change the virtual LAN VL₁ by using an IP address provided by another device (not shown) connected to the virtual LAN switch 200, the virtual LAN controller 400, and the virtual LAN switch 200.

The virtual LAN controller 400 includes a management interface 410 in order for the terminals (300₁-300₆) to conveniently access the virtual LAN switch 200, and it is connected to the outside through the network 500. The virtual LAN controller 400 has its own IP address, and can be directly connected to the network 500. The virtual LAN controller 400 is described to have a proper IP address in the embodiment of the present invention, and without being restricted to this embodiment, it can be connected to the network 500 by receiving an IP address from a network service provider or another service provider that performs the equivalent function.

When the terminals (300₁-300₆) access the virtual LAN controller 400 directly or through the management interface 410, the virtual LAN controller 400 provides authority to change the virtual LAN or an additional user account/authority to the terminals (300₁-300₆) to perform a limited control function. For example, the virtual LAN controller 400 provides authority to change the virtual LAN to the accessed terminal from among the terminals (300₁-300₆) so as to change setting of the virtual LAN, and controls the same for other terminals so that the other terminals may not change setting of the virtual LAN.

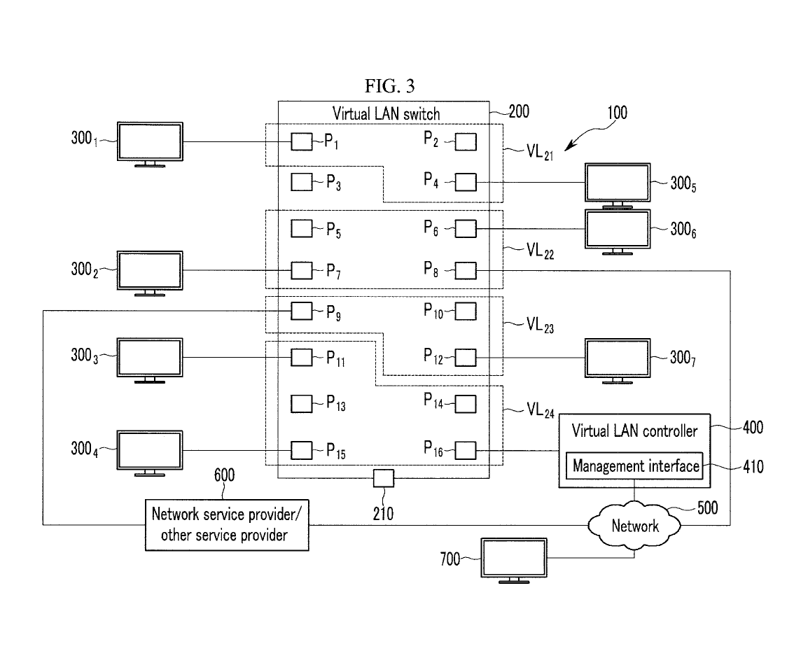

FIG. 3 shows an example of a changed virtual LAN circumstance under the initial circumstance shown in FIG. 2.

As shown in FIG. 3, in the virtual LAN control system 100 according to an exemplary embodiment of the present invention, the terminals (300₁-300₇) access the virtual LAN controller 400 directly or through the management interface 410 to change the setting of the initial virtual LAN VL₁ to the virtual LAN's (VL₂₁-VL₂₄). The virtual LAN according to an exemplary embodiment of the present invention can be configured by a port-based method, a media access control (MAC) address-based method, and a protocol-based method, and so forth, and if needed, a combination of at least two methods.

The terminal 300₁ accesses the communication port P₁ of the virtual LAN switch 200, and the terminal 300₅ accesses the communication port P₄ to set a virtual LAN VL₂₁ to the virtual LAN switch 200. The virtual LAN VL₂₁ is not connected to the virtual LAN controller 400, and performs communication between the connected terminals 300₁ and 300₅. That is, since the terminals 300₁ and 300₅ cannot access the virtual LAN controller 400 to change the setting of the virtual LAN, the manager changes the setting of the virtual LAN switch 200 and the virtual LAN through the virtual LAN controller 400.

The terminal 300₂ accesses the communication port P₇ of the virtual LAN switch 200 and the terminal 300₆ accesses the communication port P₆ to set a virtual LAN VL₂₂ to the virtual LAN switch 200. In this instance, the terminals 300₂ and 300₆ have proper IP addresses for connecting to the network 500, and are directly connected to the network 500 through the virtual LAN VL₂₂. The terminals 300₂ and 300₆ access the virtual LAN controller 400 directly or through the management interface 410 passing through the network 500 to change the setting of the virtual LAN.

The terminal 300₇ accesses the communication port P₁₂ of the virtual LAN switch 200 to set the virtual LAN VL₂₃ to the virtual LAN switch 200. In this instance, the terminal 300₇ does not have a proper IP address since it is not connected to the network 500, but it receives an IP address controlled by a network service provider connected to the communication port P₁₁ of the virtual LAN VL₂₃ or another service provider 600 that performs the equivalent function. The terminal 300₇ accesses the network 500 by passing through the network service provider or the other service provider 600, and accesses the virtual LAN controller 400 directly or through the management interface 410 via the network 500 to change the setting of the virtual LAN.

The virtual LAN VL₂₄ that is set when the terminal 300₃ accesses the communication port P₁₁ of the virtual LAN switch 200 and the terminal 300₄ accesses the communication port P₁₅ forms the same configuration as the virtual LAN VL₁ in the initial circumstance shown in FIG. 2. The terminals 300₃ and 300₄ access the virtual LAN controller 400 through the virtual LAN VL₂₄ to change the setting of the virtual LAN.

An external terminal 700 that is connected not directly to the communication port of the virtual LAN switch 200 but to the network 500 accesses the virtual LAN controller 400 directly or through the management interface 410 via the network 500 to change the setting of the virtual LAN.

The management interface 410 according to an exemplary embodiment of the present invention authenticates the terminals (300₁-300₇, 700) having accessed from the inside/outside, and controls their access to control the access authority of part or all of the terminals (300₁-300₇, 700) to the virtual LAN switch 200.

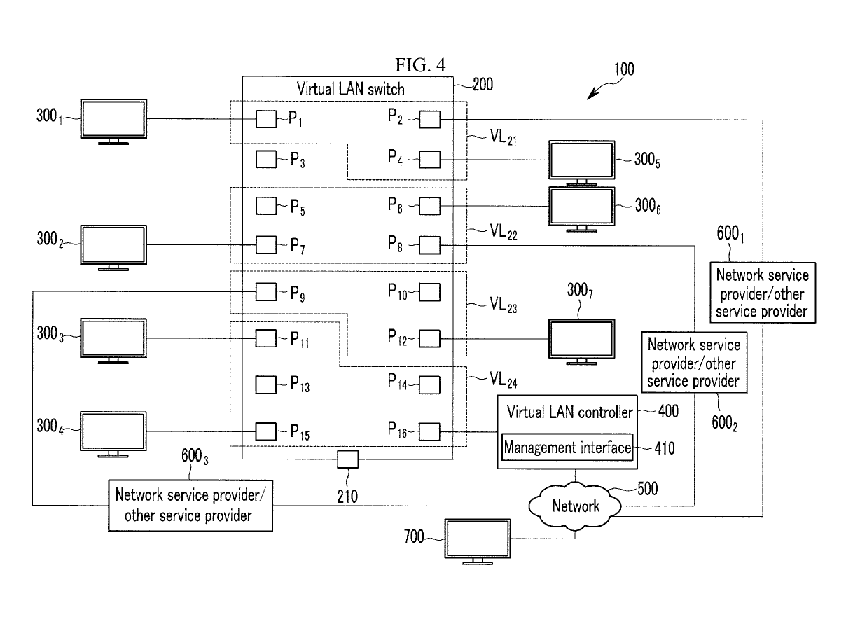

FIG. 4 shows another example of a changed virtual LAN circumstance under the initial circumstance shown in FIG. 2.

As shown in FIG. 4, in another example of the virtual LAN control system 100 according to an exemplary embodiment of the present invention, the terminal 300₁ accesses the communication port P₁ of the virtual LAN switch 200 and the terminal 300₅ accesses the communication port P₄ to set the virtual LAN VL₂₁ to the virtual LAN switch 200. The terminals 300₁ and 300₅ do not have their own IP addresses because they are not connected to the network 500, but they receive IP addresses controlled by a network service provider or an equivalent service provider 600₁ connected to the communication port P₂ of the virtual LAN VL₂₁. The terminals 300₁ and 300₅ access the network 500 by passing through the network service provider or an equivalent service provider 600₁, and access the virtual LAN controller 400 directly or through the management interface 410 by passing through the network 500 to change the setting of the virtual LAN.

In a like manner, the terminals 300₂ and 300₆ having accessed the virtual LAN VL₂₂ receive IP addresses controlled by a network service provider connected to the communication port P₈ of the virtual LAN VL₂₂ or an equivalent service provider 600₂, and access the virtual LAN controller 400 directly or through the management interface 410 by passing through the network 500 to change the setting of the virtual LAN. Further, the terminal 300₇ having accessed the virtual LAN VL₂₃ receives an IP address controlled by a network service provider connected to the communication port Pg of the virtual LAN VL₂₃ or an equivalent service provider 600₉, and accesses the virtual LAN controller 400 directly or through the management interface 410 by passing through the network 500 to change the setting of the virtual LAN.

The virtual LAN VL₂₄ that is set when the terminal 300₃ accesses the communication port P₁₁ of the virtual LAN switch 200 and the terminal 300₄ accesses the communication port P₁₅ forms the same configuration as the virtual LAN VL₁ in the initial circumstance shown in FIG. 2. The terminals 300₃ and 300₄ access the virtual LAN controller 400 through the virtual LAN VL₂₄ to change the setting of the virtual LAN.

In addition, the external terminal 700 that is not directly connected to the communication port of the virtual LAN switch 200 but is connected to the network 500 can access the virtual LAN controller 400 directly or through the management interface 410 by passing through the network 500 to change the setting of the virtual LAN.

When the terminal 300₆ having accessed the virtual LAN VL₂₂ is not satisfied with the service provided by the current network service provider or the equivalent service provider 600₂ and desires to receives the service from another network service provider, the terminal 300₆ accesses the virtual LAN controller 400 by passing through the network service provider or the equivalent service provider 600₂ and the network 500 and sets to include the terminal 300₆ to the other virtual LAN differing from the virtual LAN VL₂₂. Therefore, the subscriber or the terminal can actively choose the network service provider as he wishes and can receive the service.

Accordingly, instead of changing the virtual LAN through the manager that has the authority, since the virtual LAN switch 200 of the virtual LAN control system 100 according to an exemplary embodiment of the present invention changes the setting of the virtual LAN through the network accessed through the communication port, it can actively select and set the desired virtual LAN and can further remotely change the setting of the virtual LAN through the terminal that is not connected to the virtual LAN switch 200.

According to an embodiment of the present invention, a virtual LAN can be actively selected and controlled by controlling the virtual LAN through the network instead of passively being configured by the manager.

Also, according to an exemplary embodiment of the present invention, it is possible to remotely control the setting of a virtual LAN through a terminal that is not connected to a virtual LAN switch by controlling the virtual LAN through the network.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A virtual local area network (LAN) control system comprising:
a virtual LAN switch for setting and providing at least one virtual LAN through a network;
a terminal having a proper identifier address for accessing the network or receiving a proper identifier address through an external device connected to the virtual LAN switch; and
a virtual LAN controller for, when the terminal accesses to request to change the virtual LAN, providing authority to change virtual LANs to the terminal in order for the terminal to change a setting from the current virtual LAN to another virtual LAN.

2. The system of claim 1, wherein
the virtual LAN switch includes:
a plurality of communication ports to which the terminal and the virtual LAN controller are accessed to access the network; and
a control end to which the virtual LAN controller is accessed when a manager of the virtual LAN control system tries to control the virtual LAN controller.

3. The system of claim 2, wherein
the virtual LAN controller accesses one of the plurality of communication ports and the control end.

4. The system of claim 2, wherein
the virtual LAN controller includes
a management interface for providing authority to change the virtual LAN by authenticating a terminal that is connected by accessing the communication port and an external terminal that is accessed through a network connected to the virtual LAN controller.

5. The system of claim 4, wherein,
when the authority to change the virtual LAN for the terminals connected to the communication port is provided to the external terminal,
the external terminal accesses the virtual LAN controller to change the virtual LAN of the corresponding terminal to another virtual LAN.

6. A system for controlling at least one virtual local area network (LAN) through a network to which a plurality of terminals are accessed, comprising:
a virtual LAN switch for setting and providing the at least one virtual LAN through the network according to the access of the plurality of terminals; and
a virtual LAN controller connected to the virtual LAN switch and when a first terminal of the plurality of terminals accesses to request to change a virtual LAN, providing authority to change the virtual LAN to the first terminal so as to change the first virtual LAN to which the first terminal belongs to a second virtual LAN.

7. The system of claim 6, wherein
the virtual LAN switch includes:
a plurality of communication ports to which the terminal and the virtual LAN controller are accessed to access the network; and
a control end to which the virtual LAN controller is accessed when a manager of the virtual LAN control system attempts to control the virtual LAN controller.

8. The system of claim 6, wherein
the virtual LAN controller is connected to one of the plurality of communication ports and the control end.

9. The system of claim 6, wherein
the virtual LAN controller includes
a management interface for providing authority to change the virtual LAN by authenticating a terminal connected by accessing the communication port and an external terminal accessed through a network connected to the virtual LAN controller.

10. The system of claim 9, wherein,
when the authority to change the virtual LAN for the terminals connected to the communication port is provided to the external terminal,
the external terminal accesses the virtual LAN controller to change the virtual LAN of the corresponding terminal to another virtual LAN.

11. A virtual local area network (LAN) control system including a virtual LAN switch for setting and providing at least one virtual LAN and a virtual LAN controller for accessing the virtual LAN switch and providing authority to change a setting of the at least one virtual LAN, comprising
a plurality of terminals for receiving authority to change a setting of the at least one virtual LAN from the virtual LAN controller,
wherein the plurality of terminals are connected to communication ports of the virtual LAN switch.

12. The system of claim 11, wherein
the plurality of terminals respectively have a proper identifier address when the network is connected to the at least one virtual LAN.

13. The system of claim 11, wherein
the plurality of terminals receive proper identifier addresses from an external device when the external device is connected to the at least one virtual LAN.

14. The system of claim 13, wherein
the plurality of terminals pass through the external device by using the proper identifier addresses transmitted by the external device, and access the virtual LAN controller to change the setting to the at least one virtual LAN.

15. The system of claim 11, wherein
the plurality of terminals access the virtual LAN controller to change the setting to the at least one virtual LAN when the virtual LAN controller is connected to the at least one virtual LAN.
